(19) United States
(12) Patent Application Publication
(10) Pub. No.: US 2025/0263571 A1
(43) Pub. Date: Aug. 21, 2025

(54) Ink Jet Recording Method And Recording Apparatus

(71) Applicant: SEIKO EPSON CORPORATION, Tokyo (JP)

(72) Inventors: Jun ITO, Shimosuwa (JP); Kentaro HARA, Shiojiri (JP); Kunihiro FUJITA, Shiojiri (JP)

(21) Appl. No.: 19/056,062

(22) Filed: Feb. 18, 2025

(30) Foreign Application Priority Data
Feb. 19, 2024 (JP) 2024-023041

(51) Int. Cl. C09D 11/38; B41J 2/155; B41J 3/60; B41J 13/076; C09D 11/033; C09D 11/102

(52) U.S. Cl. CPC C09D 11/38; B41J 2/155; B41J 3/60; B41J 13/076; C09D 11/033; C09D 11/102

(57) ABSTRACT

An ink jet recording method includes a first adhesion step of ejecting an ink composition from an ink jet head to cause the ink composition to adhere to one face of a recording medium, a feeding step of transporting the recording medium by a transport roller to feed another face as a face opposite the one face subjected to the first adhesion step to a position facing the ink jet head, and a second adhesion step of ejecting the ink composition from the ink jet head to cause the ink composition to adhere to the other face fed. The ink composition contains a pigment, an acetylene glycol-based surfactant, a lactam compound having a lactam ring as a six- to eight-membered ring, a solvent component, and a water-soluble urethane resin dissolved in the solvent component. The solvent component contains water, and the ink composition is an aqueous ink.

The present application is based on, and claims priority from JP Application Serial Number 2024-023041, filed Feb. 19, 2024, the disclosure of which is hereby incorporated by reference herein in its entirety.

### BACKGROUND

### 1. Technical Field

The present disclosure relates to an ink jet recording method and a recording apparatus.

### 2. Related Art

An ink jet recording method enables high-definition image recording by a relatively simple apparatus and has been rapidly developed in many fields. In this development, various studies on ejection stability and the like when double-sided printing is performed using an ink composition have been conducted. For example, JP-A-2020-006556 discloses an ink jet recording apparatus in which an ink contains colloidal silica and a control unit controls a drying unit or a transport unit so as to start drying the ink within 0.4 seconds after the ink adheres to a recording medium in order to improve paper stacking properties due to a reduction in wet friction.

In a recording apparatus before an ink such as an aqueous ink composition sufficiently dries, a recording medium is transported, discharged, and stacked. When double-sided printing is performed, after printing is performed on a first recording face, it comes into contact with a transport roller in order to immediately invert the recording medium, thereby causing the ink to adhere to a contact face of the transport roller, which makes a recording medium to be transported next likely to be contaminated.

There are problems of such contamination by the ink and the worsening of the ejection stability of the ink and clogging recoverability when such contamination by the ink is attempted to be inhibited.

### SUMMARY

An ink jet recording method of the present disclosure includes a first adhesion step of ejecting an ink composition from an ink jet head to cause the ink composition to adhere to one face of a recording medium, a feeding step of transporting the recording medium by a transport roller to feed another face as a face opposite the one face subjected to the first adhesion step to a position facing the ink jet head, and a second adhesion step of ejecting the ink composition from the ink jet head to cause the ink composition to adhere to the other face fed. The ink composition contains a pigment, an acetylene glycol-based surfactant, a lactam compound having a lactam ring as a six- to eight-membered ring, a solvent component, and a water-soluble urethane resin dissolved in the solvent component. The solvent component contains water, and the ink composition is an aqueous ink.

A recording apparatus of the present disclosure is an ink jet recording apparatus for obtaining a recorded product by the ink jet recording method described above and includes the ink composition, the ink jet head, and the transport roller.

### BRIEF DESCRIPTION OF THE DRAWINGS

FIG. 1 is Table 1 listing the compositions of ink compositions for use in examples and their evaluation results.

FIG. 2 is Table 2 listing the compositions of ink compositions for use in comparative examples and their evaluation results.

FIG. 3 is a diagram of an example of an ink jet recording apparatus for use in an ink jet recording method.

FIG. 4 is a diagram of an example of the ink jet recording apparatus for use in the ink jet recording method.

### DESCRIPTION OF EMBODIMENTS

An embodiment of the present disclosure (hereinafter referred to as the “present embodiment”) will be described in detail with reference to the drawings as needed, but the present disclosure is not limited to this embodiment and can be modified in various ways without departing from the gist thereof. In the drawings, the same components are denoted by the same symbols, with duplicate descriptions omitted. Positional relations such as up, down, left, and right are assumed to be based on the positional relations illustrated in the drawings unless otherwise specially noted. Furthermore, the dimensional ratios in the drawings are not limited to the illustrated ratios.

### 1. Ink Jet Recording Method

The ink jet recording method according to the present embodiment (hereinafter also referred to simply as the “present recording method”) includes a first adhesion step of ejecting an ink composition from an ink jet head to cause the ink composition to adhere to one face of a recording medium, a feeding step of transporting the recording medium by a transport roller to feed another face as a face opposite the one face subjected to the first adhesion step to a position facing the ink jet head, and a second adhesion step of ejecting the ink composition from the ink jet head to cause the ink composition to adhere to the other face fed. The ink composition contains a pigment, an acetylene glycol-based surfactant, a lactam compound having a lactam ring as a six- to eight-membered ring, a solvent component, and a water-soluble urethane resin dissolved in the solvent component. The solvent component contains water, and the ink composition is an aqueous ink.

When recording is performed on both faces of the recording medium using an aqueous ink composition, there is a problem in that if the recording medium is transported and discharged by the transport roller immediately after the ink composition adheres to the recording medium, the ink composition that is not dried adheres to the transport roller or the ink composition adhering to the transport roller adheres to a contact face of a discharged recorded product to be transferred thereto. Such transfer is considered to be caused by insufficient permeation of the ink composition to the recording medium. Thus, as means for inhibiting transfer, improvement in permeability is desired. When the ink quickly permeates the recording medium, the ink permeates into the recording medium before the recording medium comes into contact with the transport roller or another recording medium, thus inhibiting transfer.

Even if the ink composition sufficiently permeates and is sufficiently absorbed into the recording medium, before drying, the ink may still be transferred to rollers in a recording apparatus or another recording medium. Concerning this point, it is considered that by adding resin particles as a fixing resin to the ink composition to obtain ink fixability and to inhibit the transfer of the ink, but such a resin is likely to flocculate to become foreign matter in an air-liquid interface during storage in an ink container, which newly causes a problem of ejection reliability. Thus, as means for inhibiting transfer without degrading ejection reliability, a component instead of such a resin is desirably used.

In addition, transfer occurs in an early stage after the ink adheres to the recording medium and occurs in a state when the ink does not sufficiently dry. Given this, it is considered that it is effective that in a state when the ink adhering to the recording medium does not sufficiently dries or in an early stage after the ink adheres to the recording medium, a coating is formed on the surface of the recording medium to which the ink adheres to inhibit transfer even before the adhering ink sufficiently dries.

Concerning this, in the present embodiment, to improve the permeability of the ink, an acetylene glycol-based surfactant is used as a component to improve permeability. In addition, by using a water-soluble urethane resin that is less likely to form foreign matter, a film is formed on the surface of the recording medium in an early stage without degrading clogging recoverability to enable transfer inhibition.

However, there is a tendency that using the acetylene glycol-based surfactant easily causes the phase separation of the ink composition and reduces storage stability. Given these circumstances, a lactam compound having a lactam ring as a six- to eight-membered ring is used in combination. This inhibits the phase separation of the ink composition and improves storage stability.

Thus, an ink composition having excellent clogging recoverability, transfer resistance, and storage stability can be provided.

It is considered that the ink composition of the present disclosure has excellent clogging recoverability, transfer resistance, and storage stability as a synergistic effect by using the above components in combination. However, the cause is not limited to the above.

The following describes the details of the steps included in the present recording method and the ink composition for use in the present recording method.

The present recording method includes a first adhesion step of ejecting an ink composition from an ink jet head to cause the ink composition to adhere to one face of a recording medium, a feeding step of transporting the recording medium by a transport roller to feed another face as a face opposite the one face subjected to the first adhesion step to a position facing the ink jet head, and a second adhesion step of ejecting the ink composition from the ink jet head to cause the ink composition to adhere to the fed other face. The present recording method having the first adhesion step and the second adhesion step means performing recording on both sides of the recording medium, and the present disclosure is particularly effective in such a situation.

In the first adhesion step and the second adhesion step, the ink composition is ejected from the ink jet head and is caused to adhere to the recording medium. More specifically, a pressure generation unit provided inside the ink jet head is driven to eject the ink composition put in a pressure generation chamber of the ink jet head from a nozzle. Such an ejection method is also called the ink jet method.

Examples of the ink jet head for use in the first adhesion step and the second adhesion step include a line head, which performs recording with the line system, and a serial head, which performs recording with the serial system.

The ink jet head for use in the present recording method is preferably a line head having a length of a recording area of the recording medium or more in a direction orthogonal to the direction of the transporting. The first adhesion step and the second adhesion step are preferably performed by scanning once in each of the first adhesion step and the second adhesion step while moving the relative position of the ink jet head as the line head and the recording medium. By such a recording method, while high-speed printing is enabled, there are many chances of the ink composition coming into contact with the transport roller before the ink composition permeates or dries, and the effect by the present disclosure is more effective.

In the serial system using the serial head, for example, the ink jet head is mounted on a carriage that is movable in the width direction of the recording medium. The carriage is moved along a main-scanning direction (the width direction of the recording medium), and ink droplets are ejected from a nozzle of the ink jet head in conjunction with this movement, thereby recording images on the recording medium.

In the feeding step, the recording medium that has been subjected to the first adhesion step is transported by the transport roller and is fed to a position facing the ink jet head such that the face opposite the one face subjected to the first adhesion step is a face to be subjected to the second adhesion step. This is an operation to invert the recording medium.

In this situation, the diameter of the transport roller is preferably 2 centimeters or more, more preferably 3 centimeters or more, and even more preferably 4 centimeters or more. When such a transport roller is used, a radius R of a curve when the recording medium is curved by the transport roller is large, the recording medium is less likely to be idled, and the recording medium is easily inverted, which is preferred. Thus, the rotational speed of the roller is increased, and the recording medium can be inverted in a short time, and a recording speed is increased, which is preferred. Meanwhile, in such a case, the ink adheres, the ink composition that is not yet dried is likely to be transferred to the transport roller and the like, and the effect by the present disclosure is more effective.

The upper limit of the diameter of the transport roller, which is not limited, may be 15 centimeters or less or 10 centimeters or less.

When an outer peripheral face of the transport roller is formed of rubber, it is easy to feed the recording medium that has been subjected to the first adhesion step with its upper and lower faces inverted, but the ink composition that is not yet dried is likely to be transferred to the transport roller, and in such a situation, the effect by the present disclosure is more effective.

The rubber is preferably synthetic rubber. Examples thereof include styrene-butadiene rubber, butadiene rubber, chloroprene rubber, butyl rubber, nitrile rubber, ethylene-propylene rubber, ethylene-propylene-diene rubber, acrylic rubber, urethane rubber, and silicone rubber, which are preferred.

In particular, preferred is rubber having an ethylene-propylene structure or a diene structure, such as styrene-butadiene rubber, butadiene rubber, ethylene-propylene rubber, and ethylene-propylene-diene rubber. Rubber having an ethylene-propylene structure is particularly preferred.

In the feeding step, when the recording medium moves in contact with the outer peripheral face of the transport roller over half a circumference or more, the transport direction of the recording medium can be significantly changed based on the transport roller, and the time required for inverting the recording medium and the length of a transport path for the recording medium can be reduced, which is preferred. Meanwhile, since the recording speed increases, the ink composition that is not yet dried is likely to be transferred to the transport roller, and thus the effect by the present disclosure is more effective.

The recording speed of the present recording method is preferably 4.5 m/minute or more and 15.0 m/minute or less in terms of the transport speed of the recording medium. The values correspond to a speed of performing printing on 15 to 50 sheets of A4 (length: about 30 centimeters) in 1 minute.

The recording speed is preferably 10 sheets/minute or more, more preferably 15 sheets/minute or more, and even more preferably 20 sheets/minute or more. Since the present embodiment performs double-sided printing, one sheet that is double-sided printed is one sheet. Thus, in terms of the number of pages, the number of pages/minute is double the sheets/minute.

The recording medium is preferably an A4-sized one. However, the inversion of the recording medium is performed once in recording on one sheet, which causes the possibility of ink transfer, and thus the size of the recording medium is not limited. The sheets/minute is a preferred indicator.

When the speed is within the above range or more, the time until the recording medium is transported by the transport roller after the ink adheres is short, and when recording media recorded at such a speed are discharged and stacked on a discharge section of the recording apparatus, there are many chances of the faces of the recording media coming into contact with each other before the ink composition permeates or dries, and thus the effect by the present disclosure is more effective.

The upper limit of the recording speed, which is not limited, is preferably 50 sheets/minute or less, and more preferably 40 sheets/minute or less.

### 2. Ink Composition

In the present recording method, the ink composition contains a pigment, an acetylene glycol-based surfactant, a lactam compound having a lactam ring as a six- to eight-membered ring, a solvent component, and a water-soluble urethane resin dissolved in the solvent component. The solvent component contains water. The ink composition is an aqueous ink. Using such an ink composition can provide a recording method having excellent clogging recoverability, transfer resistance, and storage stability.

### 2.1. Pigment

The ink composition contains a pigment. Examples of the pigment include self-dispersed pigments, in which hydrophilic functional groups are introduced to the surface of the pigment using a chemical reaction on the surface of pigment particles to impart dispersion stability to the pigment and to disperse the pigment. Examples of the hydrophilic functional groups include a carboxy group, a phosphorus-containing group such as a phosphoric acid group, and a sulfur-containing group such as a sulfo group.

Examples of the pigment also include resin-dispersed pigments, in which a dispersant resin as a resin adheres and adsorbs to the surface of the pigment, thereby imparting dispersion stability to the pigment to disperse the pigment. From the viewpoint of improving ejection reliability, transfer resistance, and miscibility, the self-dispersed pigments are preferably contained.

The self-dispersed pigments do not need any dispersants such as the dispersant resin for dispersing the pigment, and even when the content of the pigment in the ink is increased, the viscosity of the ink can be relatively lowered, and excellent ejection stability and color developing properties are achieved, which is preferred.

As the pigment, one may be used alone, or two or more may be used in combination.

Examples of the self-dispersed pigments include organic pigments such as azo pigments (including, for example, azo lake, insoluble azo pigments, condensed azo pigments, and chelate azo pigments), polycyclic pigments (for example, phthalocyanine pigments, perylene pigments, perinone pigments, anthraquinone pigments, quinacridone pigments, dioxazine pigments, thioindigo pigments, isoindolinone pigments, quinophthalone pigments, and the like), nitro pigments, nitroso pigments, and aniline black; inorganic pigments such as carbon black (for example, furnace black, thermal lamp black, acetylene black, channel black, and the like), metal oxides, metal sulfides, and metal chlorides; and extender pigments such as silica, calcium carbonate, and talc. Among these, from the viewpoint of producing the effect by the present disclosure more effectively and surely, carbon black is preferably used as the pigment.

The content of the pigment is preferably 1.0% by mass or more and 15% by mass or less, 3.0% by mass or more and 10% by mass or less, or 5.0% by mass or more and 8.0% by mass or less with respect to the total amount of the ink composition. There is a tendency that the content of the pigment being within the above range produces the effect by the present disclosure more effectively and surely.

### 2.2. Acetylene Glycol-Based Surfactant

The ink composition contains an acetylene glycol-based surfactant. Containing the acetylene glycol-based surfactant improves the permeability of the ink to provide excellent transfer resistance. In addition, ink ejection properties improve, and ejection stability also improves. On the other hand, the acetylene glycol-based surfactant has low water solubility, makes phase separation likely to occur in the ink composition, and tends to reduce clogging recoverability.

As the acetylene glycol-based surfactant, one may be used alone, or two or more may be used in combination.

From the viewpoint of further improving the effect by the present disclosure, the acetylene glycol-based surfactant contained in the ink composition preferably has an HLB value of 5 or less. The lower limit of the HLB value is 0 or more, and preferably 1 or more.

Furthermore, both the acetylene glycol-based surfactant with an HLB value of 5 or less and one with an HLB value of greater than 5 are preferably contained, both one with an HLB value of 5 or less and one with an HLB value of 7 or more are more preferably contained, and both one with an HLB value of 5 or less and one with an HLB value of 10 or more are even more preferably contained. In this case, the HLB value is 20 or less, and preferably 15 or less.

The acetylene glycol-based surfactant with an HLB value of 5 or less has a large tendency to improve the permeability of the ink compared to one with an HLB value of greater than 5 and, on the other hand, has a large tendency to easily cause phase separation in the ink composition. Thus, when the acetylene glycol-based surfactant with an HLB value of 5 or less and one with an HLB value of greater than 5 are contained, the content of the acetylene glycol-based surfactant in the ink can be increased, and ink ejection properties, permeability, and the inhibition of phase separation can more be improved, which is preferred.

In the present specification, the “hydrophilic lipophilic balance (HLB value)” is a value calculated by the Griffin method. Specifically, the HLB value of the surfactant can be calculated in accordance with Expression (H) below:

$$HLB value = 20 \times ( \% by mass of hydrophilic group ) \qquad ( H )$$

Examples of commercially available products of the acetylene glycol-based surfactant include Surfynol 104PG50 (HLB value=4), Surfynol 104, Surfynol 420 Surfynol 82, Surfynol DF110D, Surfynol 104S, Surfynol 420, Surfynol 82, and Surfynol MD-20 (product names, manufactured by Nissin Chemical Co., Ltd.); and Olfine E1010 (a product name, HLB value: 13 to 14, manufactured by Air Products, Inc.). From the viewpoint of producing the effect by the present disclosure more effectively and surely, the ink composition preferably contains at least either Surfynol 104PG50 or Olfine E1010 and more preferably contains Surfynol 104PG50 and Olfine E1010.

Specific examples of the acetylene glycol-based surfactant include 2,5,8,11-tetramethyl-6-dodecyne-5,8-diol and alkylene oxide adducts thereof, 5,8-dimethyl-6-dodecyne-5,8-diol and alkylene oxide adducts thereof, 2,4,7,9-tetramethyl-5-decyne-4,7-diol and alkylene oxide adducts thereof, and 4,7-dimethyl-5-decyne-4,7-diol and alkylene oxide adducts thereof.

A content A of the acetylene glycol-based surfactant is preferably 0.05% by mass or more and 5.0% by mass or less, 0.1% by mass or more and 3.0% by mass or less, or 0.2% by mass or more and 2.0% by mass or less with respect to the total amount of the ink composition. There is a tendency that the content A of the acetylene glycol-based surfactant being within the above range further improves transfer resistance, clogging recoverability, and ejection stability.

The content of the acetylene glycol-based surfactant with an HLB value of 5 or less may be within the above range, which is preferred in view of the above point. Furthermore, the content is preferably 0.1% by mass or more and 1.0% by mass or less, more preferably 0.1% by mass or more and 0.5% by mass or less, even more preferably 0.1% by mass or more and 0.4% by mass or less, and still even more preferably 0.1% by mass or more and 0.3% by mass or less.

The ink composition may contain other surfactants apart from the acetylene glycol-based surfactant. Examples thereof include fluorine-based surfactants and silicone-based surfactants. Examples of the fluorine-based surfactants include perfluoroalkyl sulfonates, perfluoroalkyl carboxylates, perfluoroalkyl phosphates, and perfluoroalkyl ethylene oxide adducts. Examples of the silicone-based surfactants include polysiloxane-based compounds and polyether-modified organosiloxanes.

The content of the other surfactants, which is not particularly limited so long as it does not hinder the effect by the present disclosure, is 0% by mass or more and 1% by mass or less, 0% by mass or more and 0.5% by mass or less, or 0% by mass or more and 0.1% by mass or less with respect to the total amount of the ink composition, for example.

### 2.3. Lactam Compound

The ink composition contains a lactam compound with a six- to eight-membered ring. The lactam compound has a structure in which a carboxy group and an amino group in the molecule form a ring by a dehydration condensation reaction. The ink composition containing the lactam compound with a six- to eight-membered ring improves transfer resistance, clogging recoverability, and ejection stability. From the same viewpoint, a lactam compound with a six-membered or seven-membered ring is preferably contained, and a lactam compound with a seven-membered ring is more preferably contained. Note that the lactam compound with an n-membered ring means that the number of atoms constituting the ring is n. As the lactam compound, one may be used alone, or two or more may be used in combination.

Specific examples of the lactam compound with a six- to eight-membered ring include ε-caprolactam, δ-valerolactam, ω-heptalactam, and 5-(methylamino) pentanoic acid lactam. ε-Caprolactam is preferably contained. There is a tendency that the ink composition containing ε-caprolactam further improves transfer resistance, clogging recoverability, and ejection stability.

In the ink composition, a mass ratio A/B of the content A of the acetylene glycol-based surfactant to a content B of the lactam compound is preferably 0.05 or more and 3.0 or less, 0.1 or more and 1.5 or less, or 0.2 or more and 1.0 or less. Furthermore, the ratio is preferably 0.25 to 0.6, and more preferably 0.3 to 0.5.

There is a tendency that the mass ratio A/B being within the above range further improves transfer resistance, clogging recoverability, and ejection stability.

The mass ratio of the content of the acetylene glycol-based surfactant with an HLB value of 5 or less to the content B of the lactam compound may be within the above range. The ratio is more preferably 0.05 to 0.3, and even more preferably 0.05 to 0.2.

The content B of the lactam compound with a six- to eight-membered ring is preferably 0.1% by mass or more and 10% by mass or less, 0.5% by mass or more and 5.0% by mass or less, or 1.0% by mass or more and 3.0% by mass or less with respect to the total amount of the ink composition. There is a tendency that the content B of the lactam compound with a six- to eight-membered ring being within the above range further improves transfer resistance, clogging recoverability, and ejection stability.

### 2.4. Water-Soluble Urethane Resin

The ink composition contains a water-soluble urethane resin dissolved in a solvent component. Containing the water-soluble urethane resin improves transfer resistance, clogging recoverability, and ejection stability. Note that as the water-soluble urethane resin, one may be used alone, or two or more may be used in combination.

The water-soluble urethane resin for use in the present embodiment is a water-soluble resin dissolved in the solvent component of the ink containing water in the ink and is not a resin adhering or adsorbing to the pigment. The water-soluble urethane resin for use in the present embodiment is not a dispersant resin for dispersing components, such as the pigment, of the ink.

The water-soluble resin is a resin in which, for example, when the resin is mixed in water at 18 by mass at a normal temperature of 25° C. and stirred, an undissolved component or turbidity in the entire mixed liquid is not apparent.

The urethane-based resin is not limited so long as it is a water-soluble resin having a urethane bond in the molecule, and examples thereof include ones having a repeating unit derived from a polyisocyanate and a polyol.

Examples of the polyisocyanate include aliphatic polyisocyanates such as tetramethylene diisocyanate, dodecamethylene diisocyanate, hexamethylene diisocyanate, 2,2,4-trimethylhexamethylene diisocyanate, and 2,4,4-trimethylhexamethylene diisocyanate; alicyclic polyisocyanates such as isophorone diisocyanate, dicyclohexylmethane-4,4-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, and 2,5- or 2,6-norbornane diisocyanate; and aromatic polyisocyanates such as tolylene diisocyanate, 2,2′-diphenylmethane diisocyanate, 2,4′-diphenylmethane diisocyanate, 4,4′-diphenylmethane diisocyanate, 4,4′-dibenzyl diisocyanate, 1,5-naphthylene diisocyanate, xylylene diisocyanate, and 1,3-phenylene diisocyanate.

Examples of the polyol, as ones having no acid radicals, include aliphatic polyether diols such as polyethylene glycol and polypropylene glycol; polyester polyols; polycarbonate polyols; diols having a carboxy group such as 2,2-dimethylol propionic acid, 2,2-dimethylol butanoic acid, 2,2-dimethylol heptanoic acid, 2,2-dimethylol octanoic acid, and tartaric acid; and diols having a sulfonic acid group such as 3-(2,3-dihydroxypropoxy)-1-propane sulfonic acid. Examples of the polyol also include polyols having a phosphate group, a phosphonate group, or the like as an acid radical.

The acid value of the water-soluble urethane resin is preferably 40 to 100 mgKOH/g, 40 to 90 mgKOH/g, 45 to 80 mgKOH/g, or 50 to 70 mgKOH/g. There is a tendency that the acid value of the water-soluble urethane resin being within the above range further improves transfer resistance, clogging recoverability, and ejection stability. The acid value may be determined by the potentiometric titration method.

The weight average molecular weight of the water-soluble resin is preferably 5,000 to 150,000, 10,000 to 100,000, 15,000 to 50,000, or 20,000 to 30,000. There is a tendency that the weight average molecular weight of the water-soluble resin being within the above range further improves transfer resistance, clogging recoverability, and ejection stability. The weight average molecular weight may be determined by the GPC method.

The content of the water-soluble resin is preferably 0.3% by mass or more and 3.0% by mass or less, 0.3% by mass or more and 2.0% by mass or less, or 0.4% by mass or more and 0.8% by mass or less with respect to the total amount of the ink composition. There is a tendency that the content of the water-soluble resin being within the above range further improves transfer resistance, clogging recoverability, and ejection stability.

Other water-soluble resins may be contained. Examples of such water-soluble resins include acrylic-based resins, polyalkyleneoxide-based resins, polyvinyl alcohol-based resins, and carboxymethyl cellulose-based resins.

### 2.5. Resin Particles

The ink composition preferably does not contain resin particles from the viewpoint of clogging recoverability. The resin particles are resin emulsions or the like. The resin particles are in a state in which resin that is not water-soluble is dispersed in the ink.

The resin particles are not particularly limited so long as they are not water-soluble, and examples thereof include resin particles containing urethane-based resins, acrylic-based resins, fluorene-based resins, polyolefin-based resins, rosin modified resins, terpene-based resins, polyester-based resins, polyamide-based resins, epoxy-based resins, polyvinyl chloride-based resins, ethylene-vinyl acetate-based resins, or the like.

The ink composition preferably does not contain the resin particles in an amount of 0.1% by mass or more, more preferably does not contain them in an amount of 0.05% by mass or more, and even more preferably does not contain them in an amount of 0.00% by mass or more with respect to the total amount of the ink composition. The content of the resin particles being within the above range can produce the effect by the present disclosure more effectively and surely.

### 2.6. Solvent Component

The ink composition is an aqueous ink, contains water as a solvent component, and may further contain an organic solvent.

### 2.6.1. Water

The water is preferably one with ionic impurities excluded to the utmost. Such water is not particularly limited, and examples thereof include pure water such as ion exchanged water, ultrafiltered water, reverse osmosis water, and distilled water and ultrapure water.

The content of the water is preferably 55 to 99% by mass, more preferably 60 to 90% by mass, and even more preferably 65 to 80% by mass with respect to the total amount of the ink composition.

### 2.6.2. Water-Soluble Organic Solvent

The ink composition preferably contains a water-soluble organic solvent as the solvent component. There is a tendency that containing the water-soluble organic solvent makes the transfer resistance and the ejection stability of the ink composition excellent and inhibits evaporation of water during storage. Examples of the water-soluble organic solvent include polyhydric alcohols, glycol ethers, nitrogen-containing solvents, esters, and cyclic esters. Among these, polyhydric alcohols are preferably contained as the water-soluble organic solvent.

Polyhydric alcohols have two or more hydroxy groups in the molecule, and examples thereof include polyols and alkanediols.

Examples of specific compounds of polyols include ethylene glycol, propylene glycol, 1,2-propanediol, 1,2-butanediol, 1,3-propanediol, 1,4-butanediol, diethylene glycol, triethylene glycol, triethylene glycol monobutyl ether, dipropylene glycol, trimethylol propane, and glycerin.

Examples thereof include polyols having three or more hydroxy groups in the molecule, ones having an ether group in their skeleton (intermolecular condensates of alkanediols), and alkanediols having four or less carbon atoms.

Among these, from the viewpoint of producing the effect by the present disclosure more effectively and surely, glycerin, triethylene glycol, or triethylene glycol monobutyl ether is preferably used.

Examples of specific compounds of alkanediols include 1,2-hexanediol, 1,2-pentanediol, 1,2-octanediol, 1,6-hexanediol, 2-methyl-2,4-pentanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, and 2-methylpentane-2,4-diol. Among these, from the viewpoint of further improving transfer resistance, clogging recoverability, and ejection stability, 1,2-hexanediol is preferably contained.

Alkanediols having five or more carbon atoms are preferred. There is a tendency that containing an alkanediol compound having five or more carbon atoms further improves transfer resistance, ejection reliability, and ejection stability. The upper limit of the number of carbon atoms, which is not particularly limited, is 15 or less, 12 or less, or 10 or less, for example. 1,2-Alkanediols are preferred.

The solvent component of the ink composition preferably contains polyols having a normal boiling point of 280° C. or higher, such as glycerin, as the water-soluble organic solvent. There is a tendency that containing a polyol having a normal boiling point of 280° C. or higher further improves transfer resistance, clogging recoverability, and ejection stability.

The content of the polyol having a normal boiling point of 280° C. or higher in the ink is preferably 0.5 to 10% by mass, more preferably 1.0 to 7.0% by mass, even more preferably 2.0 to 6.0% by mass, and particularly preferably 3.0 to 6.0% by mass.

The content of polyhydric alcohols containing a polyol having a normal boiling point of 280° C. or higher in the ink may be within the above range.

The content of the water-soluble organic solvent is preferably 5.0% by mass or more and 40% by mass or less, 10% by mass or more and 30% by mass or less, or 15% by mass or more and 25% by mass or less with respect to the total amount of the ink composition. There is a tendency that the content of the water-soluble organic solvent being within the above range produces the effect by the present disclosure more effectively and surely.

The content of polyols is preferably 5.0% by mass or more and 30% by mass or less, or 10% by mass or more and 20% by mass or less with respect to the total amount of the ink composition. There is a tendency that being within such a range produces the effect by the present disclosure more effectively and surely.

The content of alkanediols is preferably 2.0% by mass or more and 10% by mass or less, or 3.0% by mass or more and 7.0% by mass or less with respect to the total amount of the ink composition. There is a tendency that being within such a range produces the effect by the present disclosure more effectively and surely.

### 2.7. Betaine

A betaine means a compound having a positive charge and a negative charge at positions not adjacent to each other in the molecule in which a dissociable hydrogen is not bonded to the atom having the positive charge, an intramolecular salt is formed, and the molecule as a whole does not have any charge. The betaine of the present embodiment is preferably one in which the positive charge moiety is a quaternary ammonium cation.

There is a tendency that the ink composition containing the betaine can prevent curved flight and non-ejection of the ink composition caused by drying of the ink composition at the nozzle of the ink jet head and provides excellent ejection stability.

The number of carbon atoms of the betaine compound is preferably four to 12, more preferably four to seven, and even more preferably four to six. There is a tendency that the number of carbon atoms of the betaine being within the above range further improves ejection stability.

The betaine is not particularly limited, and examples thereof include trimethylglycine, γ-butyrobetaine, homarine, trigonelline, carnitine, homoserine betaine, valine betaine, lysine betaine, ornithine betaine, alanine betaine, stachydrine, and glutamic acid betaine. Among these, trimethylglycine is preferred. There is a tendency that it further improves ejection stability. Note that as the betaine, one may be used alone, or two or more may be used in combination.

The content of the betaine is preferably 0.0% by mass or more and 15% by mass or less, 1.0% by mass or more and 10% by mass or less, or 3.0% by mass or more and 8.0% by mass or less with respect to the total amount of the ink composition. There is a tendency that the content of the betaine being within the above range produces the effect by the present disclosure more effectively and surely.

### 2.8. Other Components

The ink composition of the present embodiment may contain components other than those described above as needed. Examples of such components include pH regulators, chelating agents, and anticorrosives.

Examples of the pH regulators include inorganic acids (for example, sulfuric acid, hydrochloric acid, nitric acid, and the like), inorganic bases (for example, lithium hydroxide, sodium hydroxide, potassium hydroxide, ammonia, and the like), organic bases (triethanolamine, diethanolamine, monoethanolamine, and tripropanolamine), and organic acids (for example, adipic acid, citric acid, succinic acid, and the like). From the viewpoint of producing the effect by the present disclosure more effectively and surely, triethanolamine is preferred.

The content of the pH regulators is preferably 0.01 to 3.0% by mass, 0.1 to 2.0% by mass, or 0.5 to 1.5% by mass with respect to the total amount of the ink composition. There is a tendency that the content of the pH regulators being within the above range produces the effect by the present disclosure more effectively and surely.

### 3. Ink Jet Recording Apparatus

The ink jet recording apparatus of the present embodiment is an ink jet recording apparatus for obtaining a recorded product by the ink jet recording method described above and includes the ink composition described above, the ink jet head described above, and the transport roller described above. In the present embodiment, concerning the transport roller, the recording medium subjected to the first adhesion step is transported by the transport roller, and another face as a face opposite one face of the recording medium is fed to a position facing the ink jet head, and the second adhesion step is performed. Such a roller is the transport roller, which is a roller transporting the recording medium between the first adhesion step and the second adhesion step. The transport roller is a roller involved in an operation to invert the recording medium in particular.

For example, a roller in a transport path through which the recording medium is transported when double-sided printing is performed and through which the recording medium is not transported when single-sided printing is performed is the transport roller of the present embodiment.

A roller used for the transport of the recording medium when double-sided printing is performed and not used for the transport of the recording medium when single-sided printing is performed is the transport roller of the present embodiment. It is noted that these are examples, and the transport roller is not limited to these examples. The transport path is a path through which the recording medium is transported.

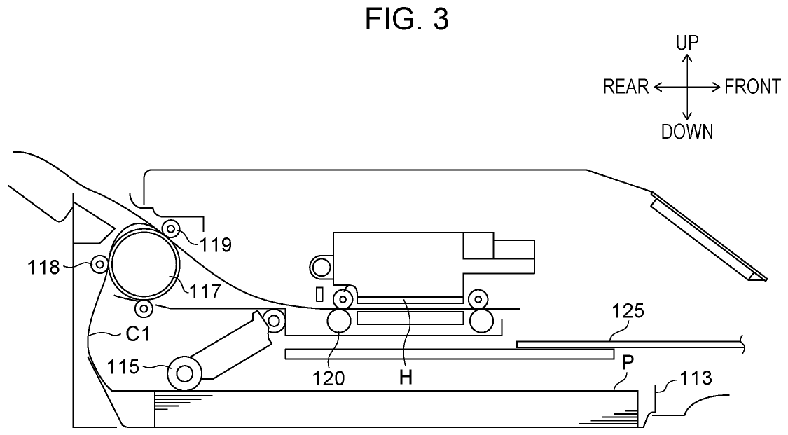

FIG. 3 illustrates an aspect of the ink jet recording apparatus. The ink jet recording apparatus may include an intermediate transport roller 117 as illustrated in FIG. 3. The transport roller 117 is a roller transporting the recording medium between the first adhesion step and the second adhesion step and is also called an intermediate roller.

The transport roller 117 is provided adjacent to a roller 118 and a roller 119 assisting the transport roller 117 while rotating following it. The transport roller 117 preferably has an outer peripheral face formed of rubber, which can impart appropriate rotational resistance to a recording medium P passing thereon, and stably transport the recording medium, and further makes the effect by the present disclosure more effective. When double-sided printing is performed, the recording medium moves in contact with the outer peripheral face of the transport roller 117, and thereby the recording medium P with its front and back inverted is again fed to the position facing an ink jet head H. When the diameter of the transport roller 117 is 2 centimeters or more, the recording medium P is easily inverted, and the effect by the present disclosure is made more effective, which is preferred.

The ink jet head H is a line head. The ink jet recording apparatus includes a motor, not shown, driving rollers such as the transport roller 117.

The following describes an example of a recording method in the ink jet recording apparatus illustrated in FIG. 3. First, in the ink jet recording apparatus illustrated in FIG. 3, the motor is forwardly rotated to rotate a pickup roller 115, thereby sending out a sheet P from a stack in a paper tray 113. The sheet P having been sent out is fed through a transport path C1 until its front end reaches a printing start position by the intermediate roller 117 and a paper feed roller 120. When the front end of the sheet P reaches the printing start position, printing on a front face is started.

After completion of the front-face printing on the sheet P, the recording apparatus performs an inverting operation of the printing face of the sheet P. The inverting operation is performed by reversely rotating the motor. When the motor is reversely rotated, the sheet P with the front face printed is sent to the rear of the recording apparatus by the paper feed roller 120 reversely rotating. The sheet P having been sent out first enters below the intermediate roller 117, goes around the forwardly rotating intermediate roller 117 thereby, and is then returned toward the paper feed roller 120 from the upper part of the intermediate roller 117. This inverts the printing face of the sheet P from the front face to a back face. Then, after the entire sheet P passes through the paper feed roller 120, the rotation direction of the motor is inverted, and with the sheet P fed until its front end reaches the printing start position, printing on the back face is started. Upon completion of the back-face printing, a controller discharges the printed sheet P to a paper discharge tray 125 to end the printing operation.

Below the intermediate roller 117 is a transport path through which the recording medium is transported when double-sided printing is performed and through which the recording medium is not transported when single-sided printing is performed, and the intermediate roller 117 present here is the transport roller of the present embodiment.

Note that the intermediate roller 117 is a roller on which the recording medium moves in contact with the outer peripheral face of the transport roller over half a circumference or more in the feeding step and may be a transport roller with a diameter of 2 centimeters or more.

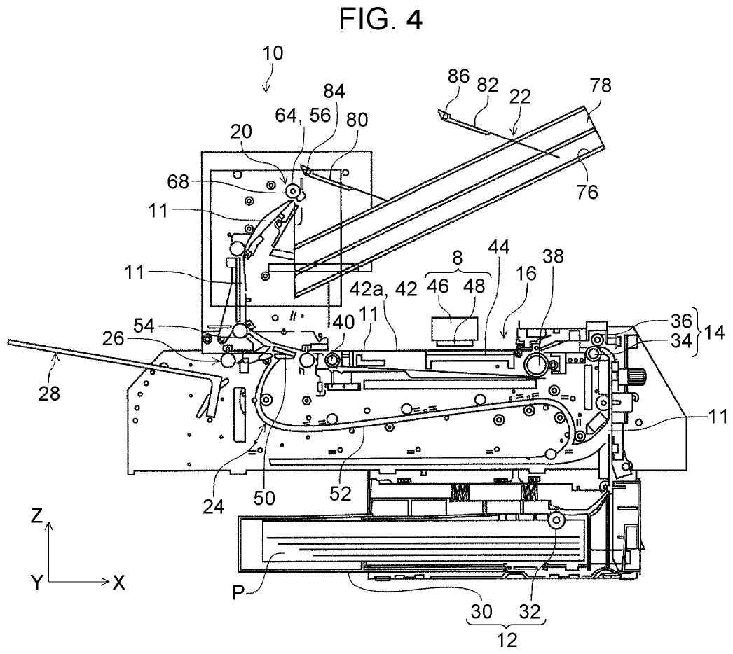

The recording apparatus example in FIG. 3 has a larger angle at which the recording medium moves in contact with the outer peripheral face of the transport roller and has a larger change angle of the transport direction of the recording medium based on the transport roller than a recording apparatus in FIG. 4, which will be described below. Thus, the length of the transport path of the recording medium in the operation of inverting the recording medium can be made relatively short, and the recording apparatus can be made small, which is preferred. In addition, even when the diameter of the transport roller is relatively large and the inverting operation is performed in a short time, the recording medium can be transported accurately, which is preferred.

When the transport roller is present closer to the ink jet head with respect to a horizontal plane including the recording face of the recording medium when the ink adhesion step is performed, the length of the transport path of the recording medium in the operation of inverting the recording medium can be made relatively short, which is preferred.

The transport roller preferably has a larger diameter than a roller positioned closest in the transport direction of the recording medium from the position of a portion of the recording medium on which the ink adhesion step is performed.

The transport roller is preferably a drive roller.

Next, FIG. 4 illustrates another aspect of the ink jet recording apparatus. The ink jet recording apparatus according to the present embodiment will be described in more detail with reference to FIG. 4. In the X-Y-Z coordinate system illustrated in FIG. 4, the X direction shows the length direction of the recording medium, the Y direction shows the width direction of the recording medium in the transport path in the recording apparatus, and the Z direction shows an apparatus height direction.

A recording apparatus 10 is, as an example, a line type ink jet printer that can perform high-speed, high-density printing. The recording apparatus 10 includes a feeding section 12 housing the recording medium P such as a sheet, a transport section 14, a belt transport section 16, a recording section 8, a face-down (Fd) discharge section 20 as a “discharge section,” a face-down (Fd) mounting section 22 as a “mounting section,” an inverted path section 24 as an “inverted transport mechanism,” a face-up (Fu) discharge section 26, and a face-up (Fu) mounting section 28.

The feeding section 12 is disposed at a lower part of the apparatus in the recording apparatus 10. The feeding section 12 includes a feeding tray 30 housing the recording medium P and a feeding roller 32 sending out the recording medium P housed in the feeding tray 30 to a transport path 11.

The recording medium P housed in the feeding tray 30 is fed to the transport section 14 along the transport path 11 by the feeding roller 32. The transport section 14 includes a transport drive roller 34 and a transport driven roller 36. The transport drive roller 34 is rotationally driven by a drive source, not shown. In the transport section 14, the recording medium P is nipped between the transport drive roller 34 and the transport driven roller 36 and is transported to the belt transport section 16 positioned downstream in the transport path 11.

The belt transport section 16 includes a first roller 38 positioned upstream in the transport path 11, a second roller 40 positioned downstream, an endless belt 42 mounted on the first roller 38 and the second roller 40 in a rotationally movable manner, and a support 44 supporting an upper section 42a of the endless belt 42 between the first roller 38 and the second roller 40.

The endless belt 42 is driven so as to move from a +X direction to a −X direction in the upper section 42a by the first roller 38 or the second roller 40 driven by a drive source, not shown. Thus, the recording medium P transported from the transport section 14 is further transported downstream in the transport path 11 in the belt transport section 16.

The recording section 8 includes a line type ink jet head 48 and a head holder 46 holding the ink jet head 48. Note that the recording section 8 may be of the serial type, in which an ink jet head is provided in a carriage reciprocally moving in the Y-axis direction. The ink jet head 48 is disposed so as to face the upper section 42a of the endless belt 42 supported on the support 44. When the recording medium P is transported in the upper section 42a of the endless belt 42, the ink jet head 48 ejects the ink toward the recording medium P to execute recording. The recording medium P, while being subjected to recording, is transported downstream in the transport path 11 by the belt transport section 16.

A first branch section 50 is provided downstream in the transport path 11 of the belt transport section 16. The first branch section 50 is configured to be able to switch between the transport path 11 transporting the recording medium P to the Fd discharge section 20 or the Fu discharge section 26 and an inverted path 52 of the inverted transport section 24 inverting the recording face of the recording medium P and again transporting the recording medium P to the recording section 8. Note that the recording medium P transported switched to the inverted path 52 by the first branch section 50, with its recording face inverted in a transport process in the inverted path 52, is again transported to the recording section 8 such that the face opposite the original recording face faces the ink jet head 48.

A second branch section 54 is further provided downstream of the first branch section 50 along the transport path 11. The second branch section 54 is configured to be able to switch the transport direction of the recording medium P so as to transport the recording medium P toward the Fd discharge section 20 or to transport the recording medium P toward the Fu discharge section 26.

The recording medium P transported toward the Fd discharge section 20 in the second branch section 54 is discharged from the Fd discharge section 20 to be mounted on the Fd mounting section 22. In this process, the recording medium P is mounted such that the recording face of the recording medium P faces the Fd mounting section 22. The recording medium P transported toward the Fu discharge section 26 in the second branch section 54 is discharged from the Fu discharge section 26 to be mounted on the Fu mounting section 28. In this process, the recording medium P is mounted such that the recording face of the recording medium P is directed opposite the Fu mounting section 28.

Among the above rollers, for example, a roller present in the inverted path section 24 is the transport roller of the present embodiment.

The above describes an example in which the line type ink jet head is used, but the ink jet recording apparatus according to the present embodiment may be a printer using a serial type ink jet head (a serial printer). In the serial printer, printing is performed by, while transporting the recording medium in a transport direction, moving the ink jet head in a direction crossing the transport direction.

### 4. Recording Medium

The recording medium for use in the recording of the ink composition of the present embodiment is not particularly limited, and examples thereof include absorbent recording media, low-absorbent recording media, and non-absorbent recording media. Among them, absorbent recording media are preferred.

The absorbent recording media are not particularly limited, and examples thereof include plain paper such as paper for electrophotography having high ink permeability, ink jet paper, and fabric. Examples of the ink jet paper include paper for exclusive use of ink jet including an ink absorbing layer containing silica particles or alumina particles and an ink absorbing layer containing a hydrophilic polymer such as polyvinyl alcohol (PVA) or polyvinyl pyrrolidone (PVP).

The low-absorbent recording media are not particularly limited, and examples thereof include art paper, coated paper, and cast paper for use in general offset printing, which have relatively low ink permeability. The non-absorbent recording media are not particularly limited, and examples thereof include films and plates of plastics such as polyvinyl chloride, polyethylene, polypropylene, polyethylene terephthalate (PET), polycarbonate, polystyrene, and polyurethane; plates of metals such as iron, silver, copper, and aluminum; metal plates and plastic films produced by depositing such various metals; plates of alloys such as stainless steel and brass; and recording media obtained by coating paper base materials with films of plastics such as polyvinyl chloride, polyethylene, polypropylene, polyethylene terephthalate (PET), polycarbonate, polystyrene, and polyurethane.

### Examples

The present disclosure will be described below more specifically with reference to examples and comparative examples. The present disclosure is not limited by the following examples at all.

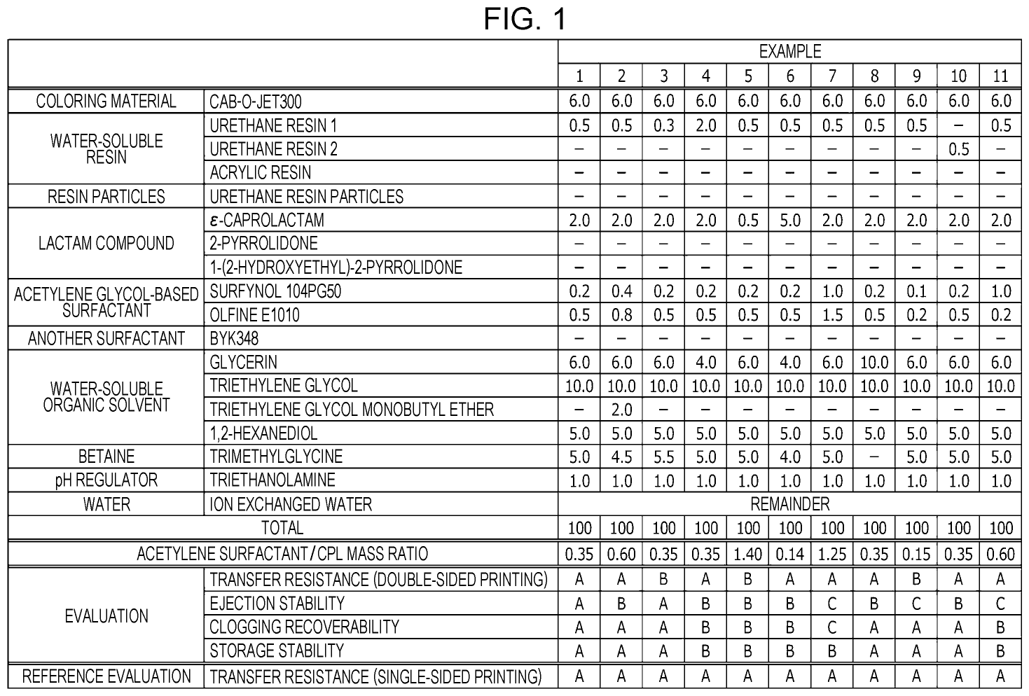

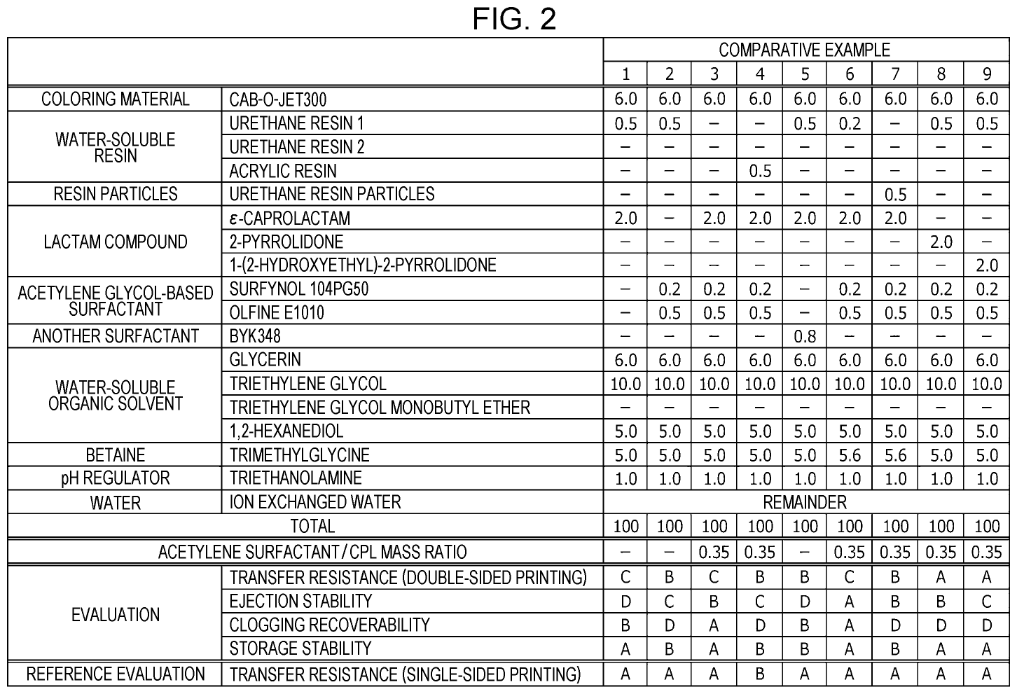

FIG. 1 and FIG. 2 describe Table 1 and Table 2 listing the compositions of ink compositions of the examples and the comparative examples and their evaluation results.

### 1. Preparation of Ink Composition

The components were put in a tank for a mixture so as to be the compositions listed in Table 1 and Table 2, were mixed together and stirred, and were further filtered using a membrane filter to obtain an ink jet ink composition of each example. Note that the values of the components shown in the examples in the tables represent % by mass unless otherwise specially described. In the tables, the values of the coloring material represent & by mass of the solid content of the coloring material.

The details of the abbreviations and product components used in Table 1 and Table 2 are as follows. The figure described on the right of the abbreviation of the solvent indicates the SP value of the solvent.

### Coloring Material

Carbon black (product name “CAB-O-JET300,” a self-dispersed pigment, manufactured by Cabot Corporation)

### Water-Soluble Resin

### Urethane Resin 1 Prepared by the Following Method

First, a four-neck flask equipped with a stirrer, a thermometer, a nitrogen gas introducing tube, and a reflux tube was prepared. Put in this four-neck flask were 41.7 parts by weight of isophorone diisocyanate, 40.1 parts by weight of polypropylene glycol (number average molecular weight: 2,000), 13.2 parts by weight of dimethylol propionic acid, and 200.0 parts by weight of methyl ethyl ketone, and the mixture was reacted at 80° C. for 6 hours in a nitrogen atmosphere (a primary reaction). Next, added thereto were 0.6 parts by weight of ethylenediamine, 2.0 parts by weight of methanol, 2.4 parts by weight of dimethylol propionic acid, and 100.0 parts by weight of methyl ethyl ketone. The remaining rate of isocyanate groups was checked by FT-IR, and the mixture was reacted at 80° C. until a desired remaining rate was achieved (secondary reaction) to obtain a reaction liquid. The obtained reaction liquid was cooled to 40° C., ion exchanged water was added thereto, and an aqueous potassium hydroxide solution was added thereto with high-speed stirring using a homomixer. Methyl ethyl ketone was distilled off from the obtained liquid by heated depressurization to obtain a liquid containing a water-soluble urethane resin 1.

As to the obtained water-soluble urethane resin 1, hydrochloric acid was added to the liquid containing the water-soluble urethane resin 1 to precipitate a water-soluble urethane resin. Then, the resin vacuum-dried overnight at 40° C. was dissolved in tetrahydrofuran to prepare a sample. The acid value of the water-soluble urethane resin 1 was measured by potentiometric titration using a potassium hydroxide-methanol titration liquid to find that the acid value was 65 mgKOH/g. As to the obtained water-soluble urethane resin 1, the weight average molecular weight in terms of polystyrene of the urethane resin measured by gel permeation chromatography (GPC) was about 21,000.

### Urethane Resin 2 Prepared by the Following Method

A water-soluble urethane resin 2 was prepared by the same preparation method as for the water-soluble urethane resin 1 except that the amount of polypropylene glycol added was reduced, and the amount of dimethylol propionic acid added in the primary reaction and the secondary reaction was increased in the preparation of the water-soluble urethane resin 1. The acid value and the weight average molecular weight were measured by the same measurement methods as for the water-soluble urethane resin 1 to find that the water-soluble urethane resin 2 had an acid value of 75 mgKOH/g and a weight average molecular weight of about 21,000.

### Acrylic Resin Prepared by the Following Method

A styrene-acrylic acid copolymer with an acid value of 65 mgKOH/g and a weight average molecular weight of 8,000 in an amount of 20.0 parts was dissolved in ion exchanged water using sodium hydroxide with the same equivalent as the acid value to obtain an aqueous solution. The obtained aqueous solution was filtered under pressure using a microfilter with a pore size of 3.0 μm (manufactured by FUJIFILM Corporation), and an appropriate amount of water was added thereto to prepare a resin aqueous solution. The content of the resin in the aqueous solution was 20.0%.

### Resin Particles

Urethane resin particles (product name “WBR-2122C,” manufactured by Taisei Fine Chemical Co., Ltd.)
Lactam compound
ε-Caprolactam
2-Pyrrolidone
1-(2-Hydroxyethyl)-2-pyrrolidone

### Acetylene Glycol-Based Surfactant

Surfynol 104PG50 (a product name, manufactured by Nissin Chemical Co., Ltd.)
Olfine E1010 (a product name, manufactured by Air Products and Chemicals, Inc.)

### Another Surfactant

BYK348 (a product name, a silicone-based surfactant, manufactured by BYK-Chemie Japan K.K.)

### Water-Soluble Organic Solvent

Glycerin
Triethylene glycol
Triethylene glycol monobutyl ether
1,2-Hexanediol

### Betaine

Trimethylglycine (an anhydrous betaine, manufactured by Tokyo Chemical Industry Co., Ltd.)

### pH Regulator

Triethanolamine

### 2. Evaluation Methods

As a recording apparatus, an apparatus obtained by modifying PX-S270T (a product name, manufactured by Seiko Epson Corporation), an ink jet printer having a double-sided printing mechanism, to make a line ink jet printer including a line head was prepared. It was configured to be the recording apparatus as in FIG. 3.

The recording apparatus includes a rubber roller for double-sided printing (diameter: 4 centimeters, ethylene-propylene-diene rubber) at a position of the roller 117 in FIG. 3 and includes a mechanism discharging a recording medium with the printing face of the first adhesion step faced down after double-sided printing. The recording medium is inverted by being transported while coming into contact with the outer peripheral face of the roller for double-sided printing. As the recording medium, “Xerox P Paper” (manufactured by Fuji Xerox Co., Ltd., basis weight: 64 g/m², paper thickness: 88 μm), A4-sized copy paper, was used, and printing was performed using the recording apparatus.

### 2.1. Transfer Resistance (Double-Sided Printing)

The ink composition obtained above was put in the recording apparatus. A black solid pattern was double-sided printed with a resolution of 600 dpi×600 dpi in an environment with a temperature of 10° C. and a relative humidity of 80%, which was continued until the thickness of stacked paper became 1 centimeter. The stacking speed in this process was 15 sheets/minute. A stacked body of recorded products obtained with a thickness of 1 centimeter was evaluated by the following method based on transfer marks on the side face of the stacked paper.

### Evaluation Criteria

A: When the stacked paper was observed at a position 30 centimeters apart, no transfer marks were visually recognized.
B: When the stacked paper was observed at a position 30 centimeters apart, transfer marks were visually recognized, but when the stacked paper was observed at a position 80 centimeters apart, no transfer marks were visually recognized.
C: When the stacked paper was observed at a position 80 centimeters apart, transfer marks were visually recognized.

### 2.2. Ejection Stability

In the above apparatus, after checking that the nozzle ejection state was normal, the ink composition described above was put therein, and a test pattern was printed on the recording medium. Subsequently, the ink jet head with the ink put therein was run without printing for 5 minutes, then the test pattern was printed again, and the number of nozzles in which landing position deviation of the ink occurred was checked. A case in which 50% or more of landing position deviation with respect to the distance between adjacent nozzles was observed was determined that landing position deviation occurred, and an evaluation was performed based on the following criteria.

### Evaluation Criteria

A: There were no nozzles in which landing position deviation occurred.
B: The number of nozzles in which landing position deviation occurred was 1% or less of the total number of nozzles.
C: The number of nozzles in which landing position deviation occurred was greater than 1% and 3% or less of the total number of nozzles.
D: The number of nozzles in which landing position deviation occurred was greater than 3% of the total number of nozzles.

### 2.3. Clogging Recoverability

The recording apparatus, after checking there were no non-ejection nozzles, was left to stand at 40° C. for one week without a cap put on the ink jet head. After being left to stand, 0.5 cc of the ink was sucked from the nozzles, and the nozzle face was wiped with a rubber wiper (cleaning). An evaluation was performed as follows based on the number of times of cleaning required until non-ejection nozzles disappeared.

### Evaluation Criteria

A: Three-time or less cleaning was performed, and non-ejection nozzles disappeared.
B: Four-time or five-time cleaning was performed, and non-ejection nozzles disappeared.
C: Six-time cleaning was performed, and non-ejection nozzles disappeared.
D: Even when six-time cleaning was performed, there were non-ejection nozzles.

### 2.4. Storage Stability

The ink composition obtained above was put in a glass bottle as a 100 mL container, which was hermetically sealed. The glass bottle was put into a thermostat chamber at 60° C. and was left to stand for one week. The glass bottle after being left to stand was taken out. After sufficiently cooling it to room temperature, viscosity measurement pursuant to JIS Z8809 was performed using a vibration type viscometer. A viscosity increase rate after being left to stand with respect to initial viscosity before being left to stand was calculated, and storage stability was evaluated based on the following criteria.

### Evaluation Criteria

A: The viscosity change rate was less than +18, and no flocculates were observed.
B: The viscosity change rate was +1% or more, but no flocculates were observed.
C: The viscosity change rate was +1% or more, and flocculates were observed.

### 3. Evaluation Results

Table 1 and Table 2 list the compositions of the inks used in the examples and their evaluation results. It is found from Table 1 and Table 2 that excellent transfer resistance is achieved when recording is performed by the ink jet recording method including a first adhesion step of ejecting an ink composition from an ink jet head to cause the ink composition to adhere to one face of a recording medium, a feeding step of transporting the recording medium by a transport roller to feed another face as a face opposite the one face subjected to the first adhesion step to a position facing the ink jet head, and a second adhesion step of ejecting the ink composition from the ink jet head to cause the ink composition to adhere to the fed other face, wherein the ink composition contains a pigment, an acetylene glycol-based surfactant, a lactam compound having a lactam ring as a six- to eight-membered ring, a solvent component, and a water-soluble urethane resin dissolved in the solvent component, and the solvent component contains water, and the ink composition is an aqueous ink.

### 4. Reference Evaluation: Transfer Resistance (Single-Sided Printing)

As a reference evaluation, the evaluation on transfer resistance was performed in the same manner as in the method for evaluating transfer resistance described above except that printing only on a single side was performed. Table 1 and Table 2 list the results. It is found from the results of the reference evaluation that the effect by the present disclosure is more effective when double-sided printing is performed.

What is claimed is:

1. An ink jet recording method comprising:
a first adhesion step of ejecting an ink composition from an ink jet head to cause the ink composition to adhere to one face of a recording medium;
a feeding step of transporting the recording medium by a transport roller to feed another face as a face opposite the one face subjected to the first adhesion step to a position facing the ink jet head; and
a second adhesion step of ejecting the ink composition from the ink jet head to cause the ink composition to adhere to the other face fed, wherein
the ink composition contains a pigment, an acetylene glycol-based surfactant, a lactam compound having a lactam ring as a six- to eight-membered ring, a solvent component, and a water-soluble urethane resin dissolved in the solvent component, and
the solvent component contains water, and the ink composition is an aqueous ink.

2. The ink jet recording method according to claim 1, wherein
a content of the water-soluble urethane resin is 0.3% by mass or more and 3.0% by mass or less with respect to a total amount of the ink composition.

3. The ink jet recording method according to claim 1, wherein
a content of the lactam compound is 0.5% by mass or more and 5.0% by mass or less with respect to a total amount of the ink composition.

4. The ink jet recording method according to claim 1, wherein
a content of the acetylene glycol-based surfactant is 0.2% by mass or more and 2.08 by mass or less with respect to a total amount of the ink composition.

5. The ink jet recording method according to claim 1, wherein
an acid value of the water-soluble urethane resin is 40 to 100 mgKOH/g.

6. The ink jet recording method according to claim 1, wherein
a mass ratio A/B of a content A of the acetylene glycol-based surfactant to a content B of the lactam compound is 0.1 or more and 1.5 or less in the ink composition.

7. The ink jet recording method according to claim 1, wherein
the pigment is a self-dispersed pigment.

8. The ink jet recording method according to claim 1, wherein
the lactam compound contains ε-caprolactam.

9. The ink jet recording method according to claim 1, wherein
the solvent component contains an organic solvent that is a polyol having a normal boiling point of 280° C. or higher.

10. The ink jet recording method according to claim 1, wherein
a diameter of the transport roller is 2 centimeters or more.

11. The ink jet recording method according to claim 1, wherein
in the feeding step, the recording medium moves in contact with an outer peripheral face of the transport roller over half a circumference or more.

12. The ink jet recording method according to claim 1, wherein
an outer peripheral face of the transport roller is formed of rubber.

13. The ink jet recording method according to claim 1, wherein
the ink jet head is a line head having a length of a recording area of the recording medium or more in a direction crossing a direction of the transporting, and
the first adhesion step and the second adhesion step are performed by scanning once in each of the first adhesion step and the second adhesion step while moving a relative position of the ink jet head and the recording medium.

14. The ink jet recording method according to claim 1, wherein
a recording speed is 15 sheets/minute or more.

15. An ink jet recording apparatus for obtaining a recorded product by the recording method according to claim 1, the ink jet recording apparatus comprising:
the ink composition;
the ink jet head; and
the transport roller.
